(19) United States
(12) Patent Application Publication
(10) Pub. No.: US 2021/0074039 A1
(43) Pub. Date: Mar. 11, 2021

(54) REAL-TIME USAGE CLASS ANALYSER BASED ON TELEMETRY DATA

(71) Applicant: Microsoft Technology Licensing, LLC, Redmond, WA (US)

(72) Inventors: Dmitry Valentinovich KHOLODKOV, Sammamish, WA (US); Donovan Allen ISAAK, Kenmore, WA (US)

(73) Assignee: Microsoft Technology Licensing, LLC, Redmond, WA (US)

(21) Appl. No.: 16/564,664

(22) Filed: Sep. 9, 2019

(51) Int. Cl. G06T 11/20; G06N 7/00; G06F 3/0484

(52) U.S. Cl. CPC G06T 11/206; G06F 3/04847; G06N 7/005

(57) ABSTRACT

Methods and systems are disclosed for classifying usage based on telemetry data for operating one or more computers. In particular, the telemetry data is received from the one or more computers as operation records. A usage graph is generated based on the telemetry data. The usage graph may include nodes as operations and directed edges that connect one node to another to represent a sequence of operations. The usage graph may be compared against a set of predefined graphical signatures as generated based on the telemetry data associated with one or more users. The graphical signatures represent distinct usage classes of the operations to identify a usage class for the usage graph. User interface tools may be provided to visually compare the usage graph and the graphical signatures to identify a usage class and to analyze efficient operations of the computers.

### BACKGROUND

The demand for collecting and analyzing information about computer executions and operations of the computer based on telemetry data has increased as computer applications become more complex. Such telemetry data is important to improve features and functionalities of the applications. The telemetry data is useful for understanding conditions associated with computer executions and/or how users of the computer have operated the computer.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

According to the present disclosure, the above and other issues may be resolved by collecting telemetry data on operations of computer applications and generating usage graphs based on the telemetry data to classify usage for various user roles.

The issues of automatically classifying usage or user roles for one or more applications may be addressed by receiving telemetry data that includes operation records, generating a usage graph based on the telemetry data, typically for a user but additionally or alternatively may be one or more users, and classifying the usage graph according to a set of graphical signatures. The set of graphical signatures provides distinct usage classes of operations. In some aspects, the graphical signatures may indicate a particular user's usage class such as, but not limited to, a content producer, a content reader, a system administrator, etc.

Graphical user interface (GUI) may be provided to display, edit, and save the usage graph and the set of graphical signatures. The GUI may provide controls to adjust various parameters of generating the usage graph and the graphical signatures from the telemetry data based on a time duration of telemetry data coverage, users, and a range of a number of occurrences of sequences of operations, for example. The GUI may also provide clipping or splitting the graphs into parts of the graphs according to conditions as specified by the operator and label the parts with markers or names of the parts.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for a usage classification system in accordance with aspects of the present disclosure.

FIG. 2 illustrates an exemplary diagram of a usage classification system in accordance with aspects of the present disclosure.

FIG. 3 illustrates an exemplary structure of a usage graph according to an example system in accordance with aspects of the present disclosure.

FIGS. 4A-4B illustrate exemplary structures of graphical signatures according to an example system in accordance with aspects of the present disclosure.

FIGS. 5A-5B illustrate data structures with which the disclosure may be practiced in accordance with aspects of the present disclosure.

FIGS. 6A-6C illustrates examples of methods of generating a usage graph and classifying a usage according to an example system with which the disclosure may be practiced in accordance with aspects of the present disclosure.

FIGS. 7A-7D illustrate examples of a user interface providing usage graphs, graphical signatures and usage classifications according to an example system with which the disclosure may be practiced in accordance with aspects of the present disclosure.

FIG. 8 is a block diagram illustrating example physical components of a computing device with which aspects of the disclosure may be practiced in accordance with aspects of the present disclosure.

FIGS. 9A and 9B are simplified block diagrams of a mobile computing device with which aspects of the present disclosure may be practiced in accordance with aspects of the present disclosure.

FIG. 10 is a simplified block diagram of a distributed computing system in which aspects of the present disclosure may be practiced in accordance with aspects of the present disclosure.

FIG. 11 illustrates a tablet computing device for executing one or more aspects of the present disclosure in accordance with aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure relates to systems and methods for automatically classifying computer usage based on telemetry data by generating and classifying usage graphs. Understanding how users operate computer applications, a word processing application and a file store, for example, is important to improve features and functionalities of computer applications as features of the computer applications become more complex. For example, product developers may be interested in understanding which features of the product the operators most frequently use and which features the operators are not using as compared to the expectations of the product developers. Product usage may be recorded as operation records and the logs may be analyzed. In some aspects telemetry data may be analyzed based on sessions. A session comprises a series of user operations as one group in terms of a time period that the operations by a user spans. Analyses based on sessions and per user may be limited because a number of usage records per user is not large enough to stochastic trends unless the user operates the computer application many times. Moreover, a user's purpose or role of using the computer application may change over time.

Operations of computer applications, either by users and/or automatic processes, may be captured and/or recorded as operation logs. In some aspects the operation logs may be captured on a client computing device, a server computing device, or both and then transmitted to a central server where the operation logs may be stored as telemetry data. Analyzing the operation logs of a user recorded for a prolonged time period may reveal one or more patterns of operations that are repeated for different purposes. Usage measurement tools typically analyze a single operation by a user at a time to determine usage statistics, such as a number of times that specific users performed the operation. Such tools, however, are not efficient in identifying sequence and patterns of operations across multiple users as the amount of processing required to analyze sequences of operations may become prohibitively large based on the types of analysis method employed, such as multi-vector analysis, for example. The present application resolves the issue of identifying and classifying operations into usage classes that represent roles using telemetry data to generating usage graphs. In examples, a usage graph depicts operations as nodes and sequences of the operations as directional edges in the graph. In further aspects, instead of focusing on individual user's operation sequences to understand usage behaviors, multiple sessions of operations across multiple users may be incorporated into usage graphs.

Users of a computer application in an organization may be classified into usage classes that represent respective usage roles. For example, some users may be classified as undertaking a role of a content producer who produces contents using the computer application. Some other users may be classified as undertaking a role of a content viewer who view content of existing files. In some organization, only a handful of the users in the organization use the computer application as content producers, while the rest of the users in the organization operates the computer application as a content viewer. In some aspects, based on telemetry data covering across multiple users over a time, a sequential, usage records may form a specific pattern when users operate the computer application under a specific user role such as being a content viewer. Such patterns may be graphically viewable and comparable by generating graphs of operations with directed edges that indicate a sequence of the operations.

For the purpose of clarity in descriptions, a usage graph is a graph with directed edges, which is built based on telemetry data for one user who operates upon a computer application for multiple times over a predetermined period of time. A graphical signature may be a labeled graph with directed edges based on telemetry data for one or more users over time, where the label specifies a usage group, a content producer, for example. In some aspects, a graphical user interface tool may be provided to display a usage graph and graphical signatures to enable visual comparison between the usage graph and graphical signatures. Moreover, the graphical user interface tool may display a graph that is built based on telemetry data of operations by multiple users over an adjustable time period to review graphical patterns of user operations and to interactively assign operation markers to the graph as a graphical signature. The operation markers may indicate usage classes that correspond to respective graphical signatures. In some other aspects, the graphical user interface tool may provide one or more folders to store portions of the graphs based on predetermined rules of characterizing graphs. For example, a rule may specify identifying a graph that contains a Save File operation. The graphical user interface tool may provide a folder that stores a portion of the graph as a graphical signature that relates to a usage class of content producer by splitting the graph in such a way to form a graph signature that contains the operation node of the Save File operation and store the graph signature in a corresponding folder.

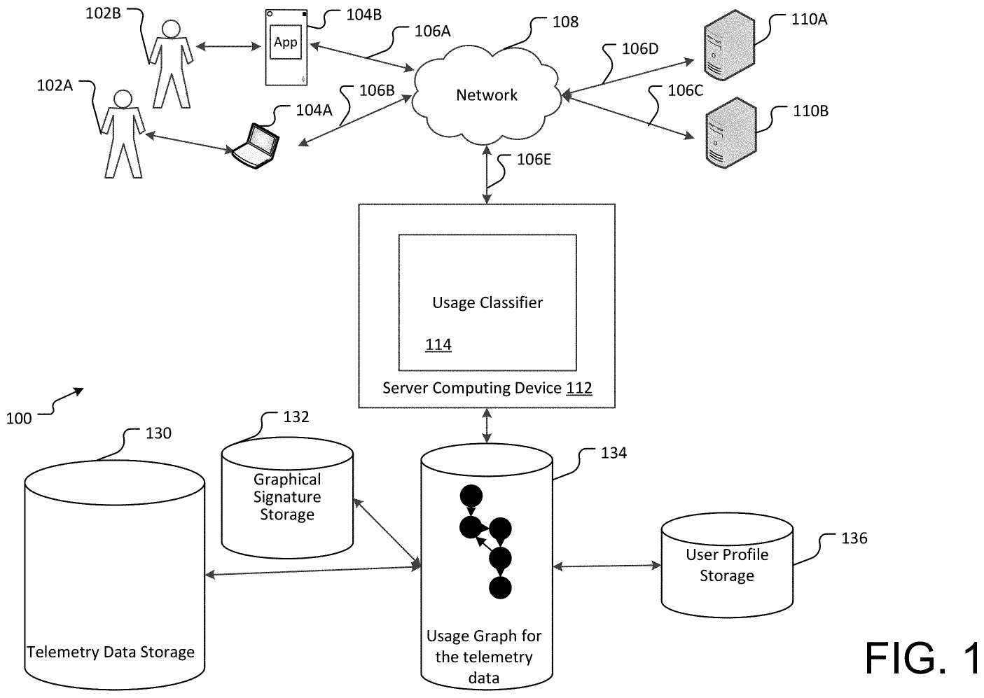

FIG. 1 illustrates an overview of an example usage classification system 100 in accordance with aspects of the present disclosure. System 100 may include one or more client computing devices 104 (e.g., client computing devices 104A and 104B) that may execute an application (e.g. a web search service application, a natural language voice recognition application, a file browser, etc.). The application may be of any type that accommodate user operations that are recorded. Telemetry data storage 130 may store telemetry data that may be received from user devices, such as but not limited to user device as users operate the computers and the servers. In some examples, loggers may execute locally on client computing devices 104A/B and collect logs of usage on computer applications to be stored as telemetry data. In some other aspects, the present application may collect operation logs from application programs that execute in server computing device (110A, 110B, and 112)

As illustrated by FIG. 1, in examples, a server version of a usage classifier application 114 is implemented by the server computing device 112. The server version of a usage classifier application 114 may also be implemented in a distributed environment (e.g., cloud computing environment) across a plurality of server computing devices (not shown). Moreover, as should be appreciated, either a client or a server version of the usage classifier application 114 may be capable of receiving operation logs from users (e.g., user 102A or 102B) as telemetry data, generate usage graphs based on the telemetry data in the telemetry data storage 130, compare the usage graphs against graphical signatures of usage classes, and identify usage classes for the telemetry data. While a server version of the usage classifier application 114 is shown and described, this should not be understood as limiting. Rather, a client version of the information search application 114 may similarly implement the information search application 114 on a client computing device 104A (or 104B).

In at least some aspects, the one or more client computing devices 104 (104A and 104B) may be personal or handheld computers operated by one or more users 102 (e.g., a user 102A and another user 102B). For example, the one or more client computing devices 104 may include one or more of: a mobile telephone; a smart phone; a tablet; a phablet; a smart watch; a wearable computer; a personal computer; a desktop computer; a laptop computer; a gaming device/computer (e.g., Xbox®); a television; and the like. This list is exemplary only and should not be considered as limiting. Any suitable client computing device for executing the usage classifier application 114 may be utilized.

In at least some aspects, network 108 is a computer network such as an enterprise intranet, an enterprise extranet and/or the Internet. In this regard, the network 108 may include a Local Area Network (LAN), a Wide Area Network (WAN), the Internet, wireless and wired transmission mediums. In further aspects, server computing device 112 and other server computing devices 110A and 110B may communicate with some components of the system via respective links 106A-E to a local network (e.g., an enterprise intranet), whereas server computing device 112 may communicate with other components of the system via a wide area network (e.g., the Internet). In addition, the aspects and functionalities described herein may operate over distributed networks (e.g., cloud computing systems), where application functionality, memory, data storage and retrieval, and various processing functions may be operated remotely from each other over a distributed computing network, such as the Internet or an intranet.

As described above, the usage classifier application 114 may be implemented on a server computing device 112. In a basic configuration, the server computing device 112 may include at least a processing unit and a system memory for executing computer-readable instructions. In at least some aspects, the server computing device 112 may comprise one or more server computing devices in a distributed environment (e.g., cloud computing environment). The server computing device 112 may generate, store and/or access a telemetry data storage 130, a graphical signature storage 132, a usage graph for the telemetry data 134, and a user profile storage 136. Some of the graphs and associated subgraphs and configurations may also be generated, stored and/or accessed by the one or more client computing devices 104 and/or one or more other server computing devices (e.g., server computing devices 110A and/or 110B) via links 106A-E.

The telemetry data storage 130 may store telemetry data of application usage. In at least some aspects, telemetry data may include a plurality of operation records. For example, an operation record may include a time stamp of the time when the operation occurs, an identifier of a user who performs the operation, and an identifier that specifies an operation. The operation record may additionally include information about a computing device where the operation occurs and a location of the computing device.

The graphical signature storage 132 may provide a set of graphical signatures of usage classes. In examples, a graphical signature is associated with a usage class. In examples, the graphical signature is a probabilistic hierarchical Markov chain-based object, which includes nodes and directed edges that connect from one node to another as sequences of operations occur. In other examples, the graphical signatures is a type of state diagrams including unstructured relationships of data with nodes that are connected by directional edges. In some aspects, the graphical signature may indicate a sequence of operations that are unique to respective usage classes. A usage class may represent or characterize a role of user operating upon a computer application. For example, some graphical signature may relate to a content producer of a content processing application. The content producer typically creates and edits content presentation materials, documents, and drawings in files. Stochastically there may be a pattern of user operations as being the content producer. In contrast to the graphical signature for the content producer, some other graphical signature may relate to a content reader of the content processing application. The content reader opens and view content of existing presentation materials, documents, and drawings in files. Stochastically there may be a pattern of user operations as being the content reader. Yet some other graphical signature may related to a system administrator of the content processing application, who may archive files and clean up storages by moving and deleting the files. The graphical signatures represent distinct usage classes of users based on types and sequences of operations that characterize roles of user operations.

In some aspects, a graphical signature may be predetermined. The graphical signature may be manually defined by use of a graphical user interface application by drawing graph structures where nodes correspond to operations and edges indicate a time sequence of the operations with likelihood for the time sequence of the operations to occur. In some other aspects, the graphical signatures may be automatically generated by parsing telemetry data of operations. The predefined graphical signatures may be generated based on rules by splitting hierarchical graph structures and associating portions into clusters of graph structures that include a node representing a specific operation Save File, for example.

The usage graph for the telemetry data 134 may store one or more usage graphs that are generated based on telemetry data in the telemetry data storage 130. In some aspects, a usage graph is a probabilistic hierarchical Markov chain-based object, which includes nodes and directed edges that connect from one node to another as sequences of operations occur. In other examples, the usage graph is a type of state diagrams including unstructured relationships of data with nodes that are connected by directional edges. In some aspects, the usage graph may indicate a sequence of operations based on operation records. A node may be based on an operation of an application. For example, an open file operation may be represented by a node. A directed edge may connect two nodes on the graph, based on a time sequence of the operations. The edge may connect from a first operation to a second operation that occurs subsequently. In examples, the edge can be associated with a count, which indicates a number of times a particular sequence of the operations that are associated by the edges occurs. That is, the count represents a number of times that the sequence between the nodes at both ends of the edge occurs. In some other aspects, the usage graphs may be automatically generated by parsing telemetry data of operations by one or more users. The usage graphs may be generated based on unsupervised machine language techniques, clustering hierarchical graph structures to identify similarities, association mining, and latent variable models, for example.

The user profile storage 136 may store data records that associate respective users and usage classes of the respective users as determined by comparing usage graphs against graphical signatures that specify usage classes. For example, the user profile storage 136 may store a user profile for a user who relates to a usage class of a content producer and another profile for another user who relates to a usage class of a content reader. In some aspects, the processor may dynamically allocate and/or release memory for storing the user profile as the user profiles change.

The usage classifier application 114 may include receiving telemetry data, generating a usage graph, retrieving a set of graphical signatures, identifying a usage class, and providing a usage class, for example). In aspects the usage classifier application 114 may communicate and pass data with other applications. The features may be implemented using hardware, software, or a combination of hardware and software. Moreover, the various features may be executed on a single server computing device (e.g., server computing device 112), on multiple server computing devices (e.g., server computing devices 112 and servers 110A and/or 110B), or at least in part locally on one or more client computing device (e.g., client computing devices 104A and/or 104B).

As should be appreciated, the various methods, devices, applications, features, etc., described with respect to FIG. 1 is not intended to limit the system 100 to being performed by the particular applications and features described. Accordingly, additional topology configurations may be used to practice the methods and systems herein and/or features and applications described may be excluded without departing from the methods and systems disclosed herein.

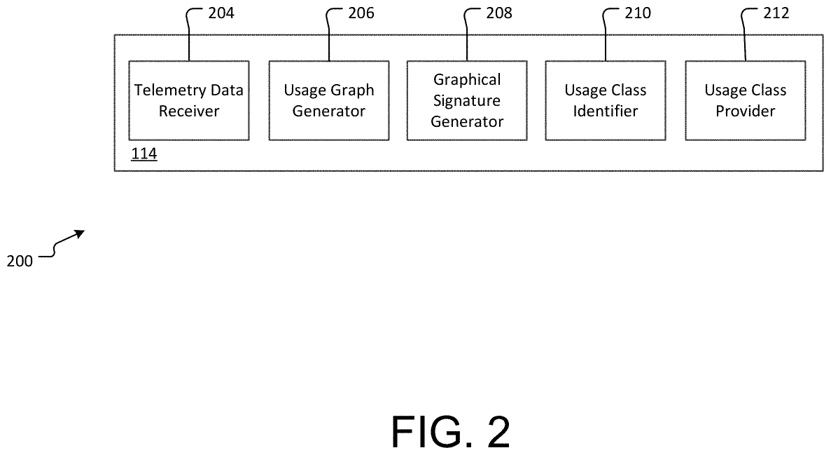

FIG. 2 illustrates an exemplary diagram of a usage classification system in accordance with aspects of the present disclosure. In at least some aspects the usage classification system 200 may be implemented on a server computing device 112. The system 200 may include at least a telemetry data receiver 204, a usage graph generator 206, a graphical signature generator 208, a usage class identifier 210, and a usage class provider 212. Additionally or alternatively, the information search system 200 may be implemented in part on the server 112 and in part in a user-specific computing device such as a client computing device (not shown in FIG. 2). In at least some aspects, the system 200 may also include a usage class query receiver (not shown in FIG. 2) and a result provider (not shown in FIG. 2). The usage class query receiver may receive a query that requests for one or more usage classes of operation records stored as telemetry data in the telemetry data storage 130. Examples of the query may include, but are not limited to, a request for a usage class or user role by specifying a user, a request for one or more usage classes of operations across multiple users over a predetermined time period, and usage graphs and matching graphical signatures for select users over a predetermined time period for comparison. The result provider may provide a result of generating usage graphs and classifying operations into usage classes.

The telemetry data receiver 204 may receive operation records as telemetry data from client computing devices (104A and 104B) and server computing devices (110A and 110B). An operation record may include as its data structure, for example, a time stamp of an operation, a user information of the user associated with the operation, an information about the operation, an information about the application that is operated upon. The telemetry data may include operation records for one or more users using one or more applications.

The usage graph generator 206 may generate a usage graph of operations upon computer applications based on telemetry data. In at least some aspects, the usage graph generator 206 may look up telemetry data from the telemetry data storage 130, parse sequences of operations, and generate a usage graph. The usage graph may be based on a probabilistic hierarchical Markov chain-based object, which includes nodes and directed edges that connect from one node to another as sequences of operations occur. In some aspects the directed edges may be one directional. In some other aspects the directed edges may be bidirectional based on a sequence of operations. The edges may include a count, which depicts a number of times that the sequence of operations occurs. In other examples, the usage graph is a type of state diagrams including unstructured relationships of data with nodes that are connected by directional edges

In some aspects, a node may represent an operation. For example, a node may represent an operation of creating a file, opening the file, editing the file, saving the file, renaming the file, copying the file, closing the file, and deleting the file. In some aspects, the usage graph generator 206 may generate a graph by selecting a pair of operations where one operation occurs subsequent to another operation as indicated by respective time stamps, generating one node for each of the operations, and generating a directed edge that connects from the node for the preceding operation to the other node for the subsequent operation. The edge may include a count that records a number of times that the sequence of the operations occur; a value of the count may be 1 (one) when it is created, for example.

The graphical signature generator 208 may generate one or more graphical signatures based on the telemetry data and store the graphical signatures in the graphical signature storage 132. In some aspects a graphical signature may represent a usage class of a user who operates one or more computer applications based on a sequence of operations and a frequency or probability of the sequence that occurs. For example, a content producer may be a usage class of a user. The content producer may represent a user who may typically create content in a computer application by creating, opening, editing, saving, and closing a file. In some other example, a content reader may be another usage class. The content reader may typically view contents by opening, viewing, and closing a file. Each usage class may relate to one or more usage graphs that distinctly represent sequences of operations for a typical type of usage. In some aspects, a graphical signature may be created manually based on operations of creating a graph with nodes and directed edges. In some other aspects, a graphical signature may be automatically created by mining the operation records.

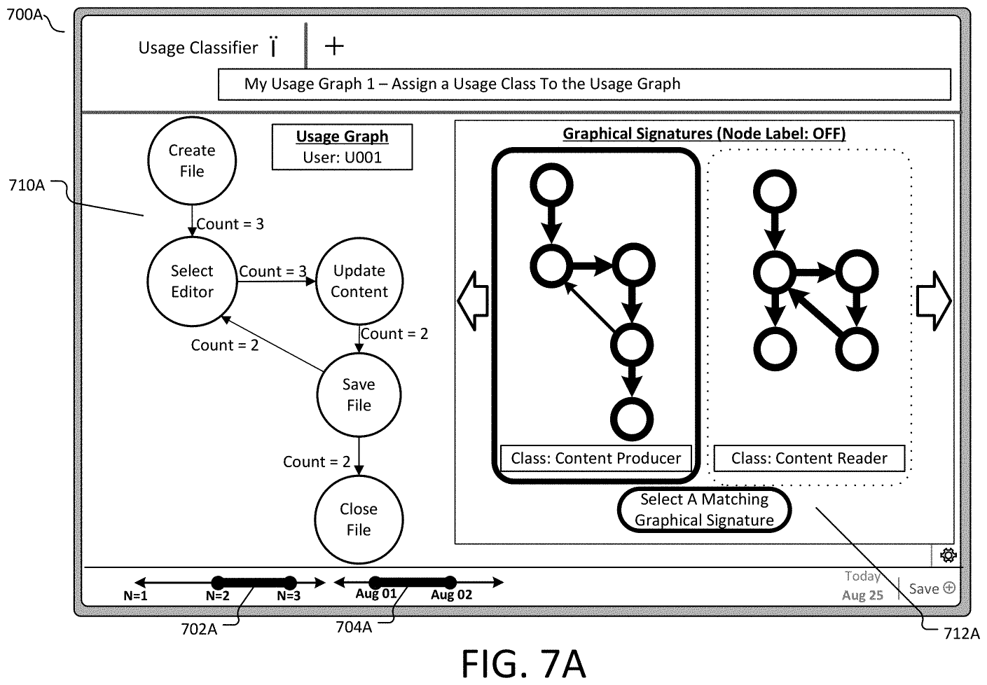

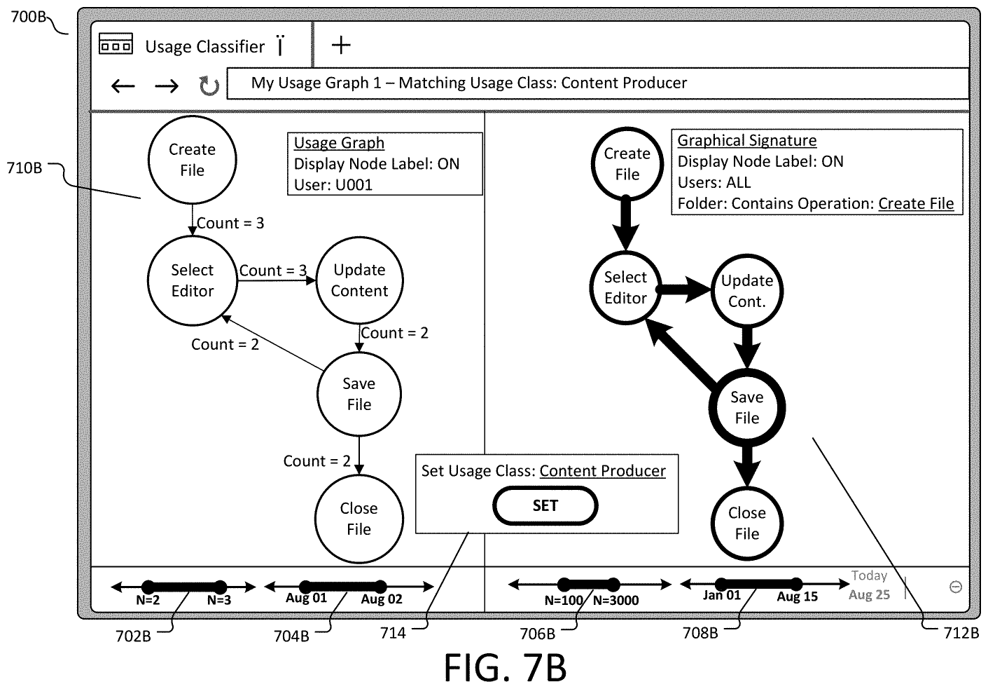

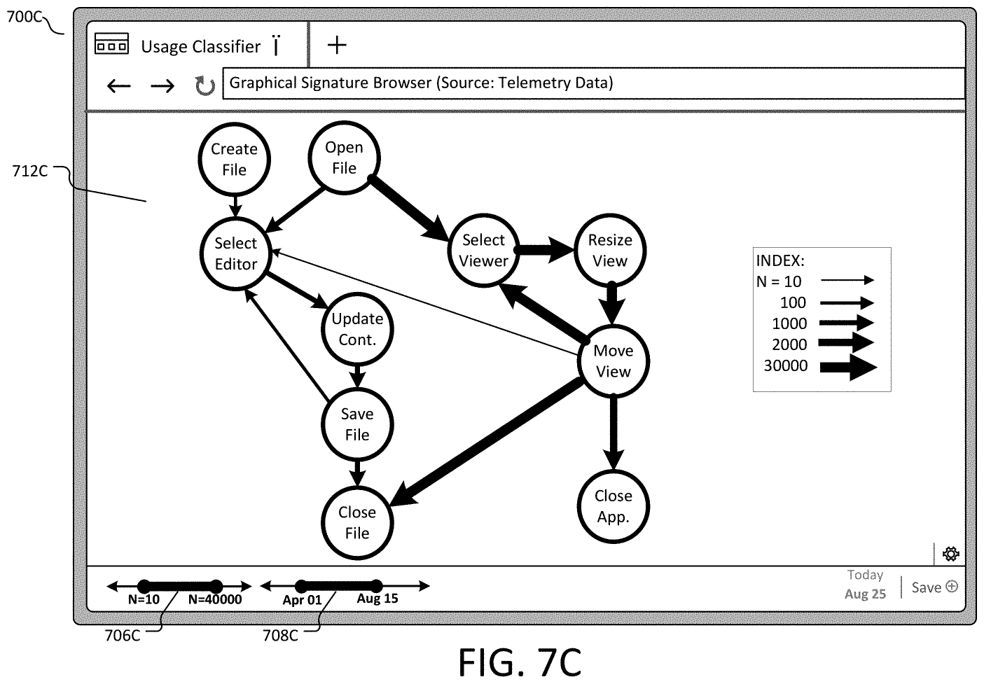

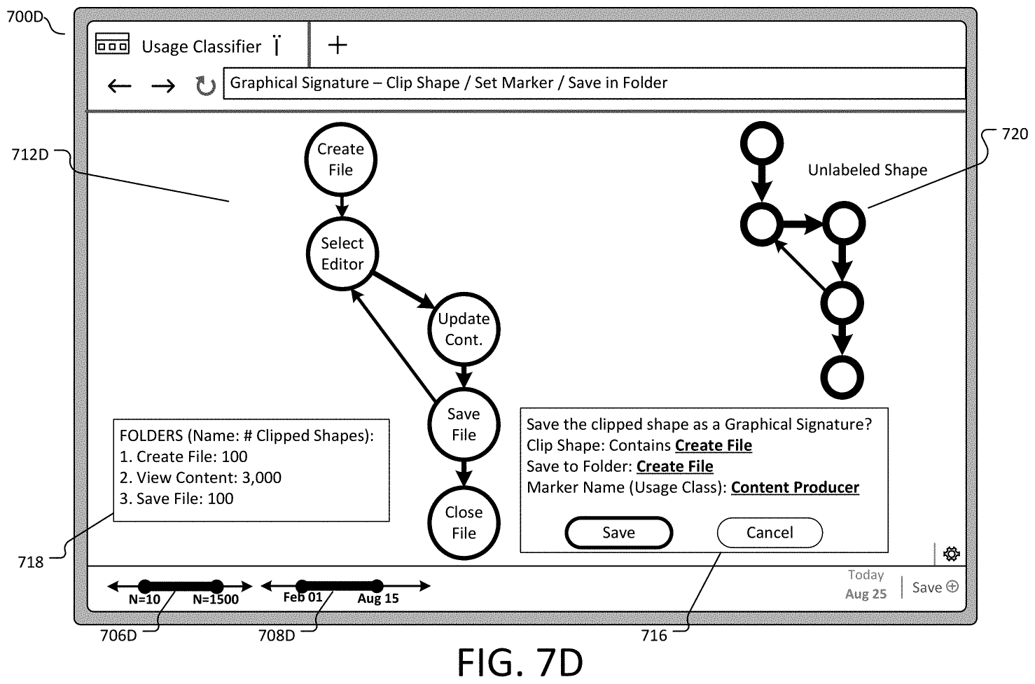

The usage class identifier 210 may identify one or more usage classes that relate to the usage graph based on comparison against the set of the graphical signatures. In some aspects the usage class identifier 210 may identify a usage class by matching the usage graph against one or more graphical signatures and finding a graphical signature that matches the usage graph based unsupervised machine learning processes. The one or more graphical signatures may be retrieved from the graphical signature storage 132 or generated in real-time based on the telemetry data as the matching with the usage graph is made. In some other aspects the usage graphs and graphical signatures may be matched and compared based on unsupervised machine language techniques, clustering hierarchical graph structures to identify similarities, association mining, and latent variable models, for example For example, the usage class identifier 210 may parse the usage graph, form clusters or segments in the user graph, and identify a graphical signature that match the clusters of the usage graph. In some aspects, the usage class identifier 210 may label clusters with usage classes that the matching graphical signatures represent. In some aspects, the user class may be identified by providing to the user with the user interface tools as shown in FIGS. 7A-7D as the graphical user interface tools, for example. Such tools may display and interactively compare the usage graph and one or more graphical signatures to identify one or more usage classes. The Graphical user interface (GUI) may be provided to display, edit, and save the usage graph and the set of graphical signatures. The GUI may provide controls to adjust various parameters of generating the usage graph and the graphical signatures from the telemetry data based on a time duration of telemetry data coverage, users, and a range of a number of occurrences of sequences of operations, for example. The GUI may also provide clipping or splitting the graphs into parts of the graphs according to conditions as specified by the operator and label the parts with markers or names of the parts.

The usage class provider 212 may provide a usage class that the usage class identifier 210 identifies. In some aspects, the usage class provider 212 may provide the usage class as visual objects and/or visual representations of the usage graph and a name of the usage class. In some other aspects, the usage class provider 212 may display the usage class via a user interface.

As should be appreciated, the various methods, devices, applications and features, etc., described with respect to FIG. 2 is not intended to limit example of the information search system 200. Accordingly, additional topology configurations may be used to practice the methods and systems herein described may be excluded without departing from the methods and systems disclosed herein.

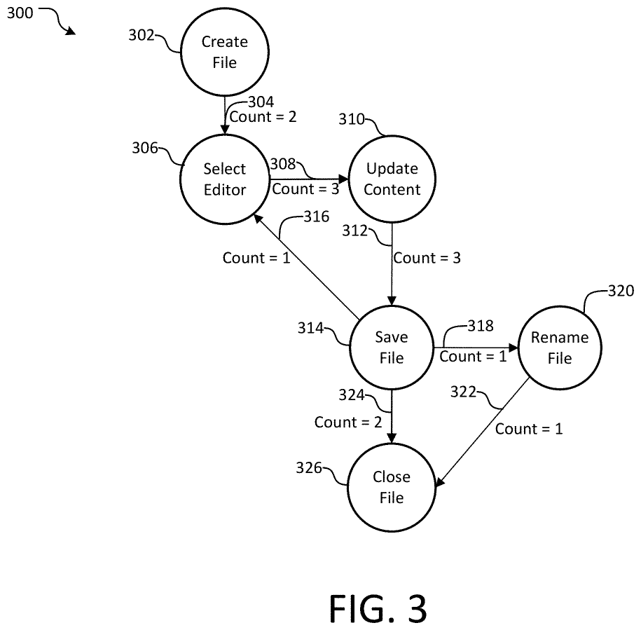

FIG. 3 illustrates an exemplary structure of a usage graph 300. In FIG. 3, the usage graph 300, as an example, includes a series of operations represented as nodes. In this scenario example, a node 302 depicts an operation “Create File.” The node represents an operation where the user creates a file. A Create-Select edge 304 connects from the create File node 302 to the Select Editor node 306, thereby indicating that the user selects the editing mode of the application for editing the file after creating the file. The Create-Select edge 304 includes a count with a value 2 (two), depicting that there are two instances of the sequence of the operations where the user creates the file and then selects the editor. A Select-Update edge 308 with count 3 (three) connects from the Select Editor node 306 to an Update Content node 310, there by indicating that there are three occurrences of the user selecting the editor and then updating content of the file. An Update-Save edge 312 with count 3 (three) connects from the Update Content node 310 to a Save File node 314, indicating that there are three occurrences of the sequence of the operation where the user updates the content and then saves the content in the file. The Save-Select edge 316 with count 1 (one) connects from the Save File node 314 to the Select Editor 306 node, indicating that there is one occurrence of the sequence of the operation of saving the contents in the file and then selecting the editor. A Save-Rename edge 318 connects from the Save File node 314 and a Rename File node 320 with count 1 (one), indicating that there has been one occurrence of the sequence of the operation where the user saves the content in the file and then renames the file. A Rename-Close edge 322 with count 1 (one) connects from the Rename File node 320 to a Close File node 326, indicating that there is one occurrence of the operation where the user renames the file and then closes the file. A Save-Close edge 324 with count 2 (two) connects from the Save File node 314 to the Close File node 326, indicating that there are two occurrences of the user saving the content in the file and then closing the file.

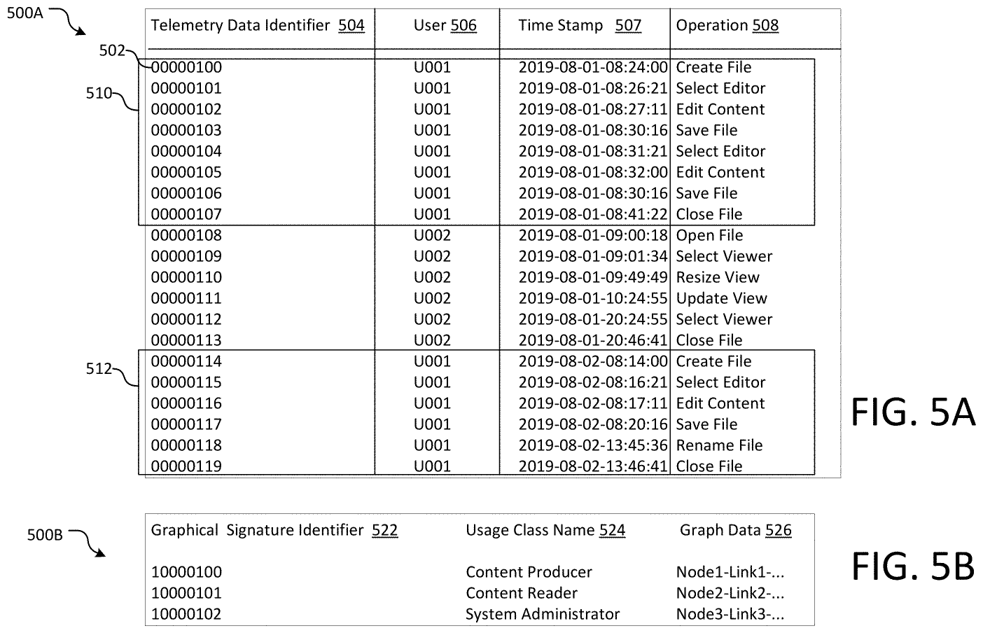

In some aspects, the usage graph generator 206 may generate the usage graph 300 based on operation records. The telemetry data stored in the telemetry data storage 130 may be a collection of operation records. For example, the usage graph 300 reflects, in part, the telemetry data of three occurrences of operations by user U001 in FIG. 5. In some aspects, the usage graph 300 may represent multiple instances of operations. The count in respective edges may indicate a number of occurrences of respective sequences of operations.

In some aspects, generating usage graphs with a number of occurrences of specific sequences of operations in the graphical forms may significantly reduce an amount of memory required to separately store respective individual sequences of operations by users. Multiple occurrences of a particular sequence of operations may be embedded into one set of nodes and edges with counts. In some aspects, the processor allocates memory to store the usage graphs and graphical signatures. The reduced memory requirement may conserve memory use and reduce needs to perform read/write operations to the memory and thus improve computing performance of processing usage classifications.

In some aspects, a usage graph is a probabilistic hierarchical Markov chain-based object, which includes nodes and directed edges that connect from one node to another as sequences of operations occur. In other examples, the usage graph is a type of state diagrams including unstructured relationships of data with nodes that are connected by directional edges. In some aspects, the usage graph may indicate a sequence of operations based on operation records. A node may be based on an operation of an application. For example, an open file operation may be represented by a node. A directed edge may connect two nodes on the graph, based on a time sequence of the operations. The edge may connect from a first operation to a second operation that occurs subsequently. In some other aspects, the directional edges may indicate weights, ratios, and/or probability of respective sequences of operations by connecting two nodes instead of counts.

As should be appreciated, the various methods, devices, applications, features, etc., described with respect to FIG. 3 is not intended to limit example of the usage graph. Accordingly, additional topology configurations may be used to practice the methods and systems herein described may be excluded without departing from the methods and systems disclosed herein.

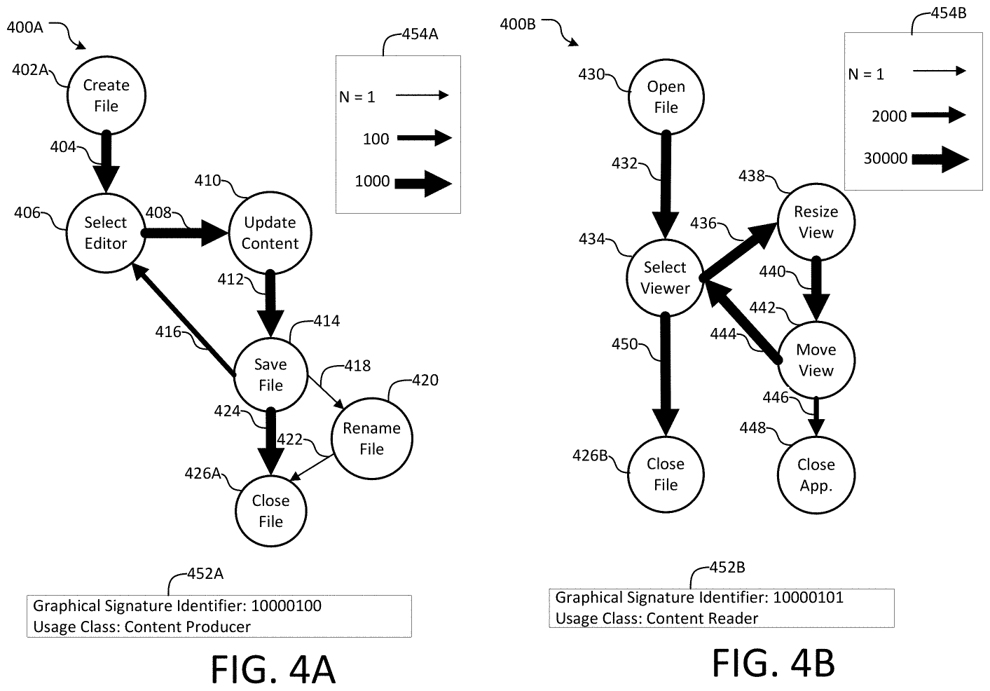

FIGS. 4A-4B illustrate exemplary structures of graphical signatures according to an example system in accordance with aspects of the present disclosure. The graph structure 400A illustrates a graphical signature having an exemplary Graphical Signature Identifier #100000100 representing an exemplary usage class for a “content producer” 452A. The graphical structure for the usage class of a content producer includes the Create File node 402A from which a Create-Select edge 404 connects with the Select Editor node 406. The Create File node 402A describes an operation of creating a file. A thickness of the directed Create-Select edge 404 may indicate a probability, a ratio, a percentage, or a number of occurrences among a typical 1000 users, of the sequence of operation where the user creates the file and then selects an editor for the file when the user's usage is classified as a content producer. Various thicknesses or types of lines of the edges may indicate a number of times, a frequency of the sequence that occurs, and/or a ratio of particular sequences of operations from a node to another node. For example, a thicker, directed edge may indicate a sequence of operations that occurs more frequently than other sequences.

In some aspects, the legend 442A of the graphical signature 400A shows three different widths for directed edges. For example, when representing a ration, the thinnest directed edge shows N=1, which indicates a ratio of 1 to 100, one hundredth, or one occurrence out of one hundred occurrences. Alternatively, the value N=1 may indicate one occurrence of the sequence in the telemetry data. The thickest direct edge shows N=1,000. For example, thicker the line is more probable or more typical the sequence of operations is. The expression of the probability, the ratio, the percentage, or the number of occurrences may not be limited to thickness of the edge in the graph. Edges may convey the information based on styles, dotted line, for example, color, in displaying. The edges may convey the information based on a tone or a strength of voice sound when the graph structure is described by sound.

The Select Editor node 406 relates to an operation of selecting an editor for the file. A Select-Update edge 408 edges from the Select Editor node 406 to an Update Content node 410. The set of Select Editor node 406, the Select-Edit edge 408 with thickness N=1,000, and the Update Content node 410 describes 1,000 occurrences of a sequence of operations where the user selects the editor for the file and then updates the content of the file, for example. The Update-Save edge 412 edges from the Update Content node 410 to the Save File node 414 at N=1,000. The Save-Select edge 416 edges from the Save File node 414 to the Select Editor node 406 at N=100. The Save-Rename edge 418 edges from the Save File node 414 to the Rename File node 420 with N=1. The Rename File node 420 represents an operation where the user renames the file. The Rename-Close edge 422 edges from the Rename File node 420 to the Close File node 426A with N=1. The Save-Close edge 424 edges from the Save File node 414 to the Close File node 426A with N=1,000. One of skill in the art will appreciate that, while exemplary operations are depicted in throughout this disclosure, aspects of the disclosure can be employed regardless of the types of operations being performed.

In some aspects, the graphical signature 400A for the usage class of a content producer shows that most users acting as a content producer follows a sequence of operations where the user opens a file, edits the file, saves the file, and then closes the file. In relatively rare occurrences, the user deletes the file after editing the file (not shown), or renames the file between saving and closing the file after making edits to the content of the file.

The graph structure 400B illustrates a graphical signature with Graphical Signature Identifier 100000101 with a usage class of a “content reader” 452B. The graphical structure for the usage class of a content producer includes the Open File node 430 from which an Open-Select edge 432 edges to the Select Viewer node 434 with N=30,000. The Select-Close edge 450 edges from the Select Viewer node 434 to the Close File node 426B with N=30,000. The Select-Resize edge 436 edges from the Select Viewer node 434 to the Resize View node 438 with N=30,000. The Resize View node 438 operation represents the operation where the user resizes the content in the view. The Resize-Move node 440 edges from the Resize View node 438 to the Move View node 442 with N=30,000. The Move View node 442 represents the operation of moving the content in the view. The Move-CloseApp edge 446 edges from the Move View node 442 to the Close Application node 448 with N=2,000. The Close Application node 448 represents the operation where the user closes the application instead of closing the file. The Move-Select edge 444 with N=30,000 edges from the Move View node 442 to the Select Viewer node 434. The Select-Close edge 450 with N=30,000 edges from the Select Viewer 434 to the Close File node 426B. In some aspects, the graphical signature for a usage class of a content reader may show a pattern of operations where the user opens the file, selects the viewer to view contents of the file, views contents of the file by resizing and moving the content in the view, and closes the file via selecting the viewer menu or simply closes the application.

In some aspects there may be significantly larger number of users who use the application as content readers than the users who use the application as content producers in an organization. As the respective legends 454A-454B for the graphical signatures for content producers and content readers indicate, the ranges of values of N (e.g., a number of occurrences) may differ. The thickest edge used in FIG. 4A represent 1,000 occurrences of sequences of operations while the thickest edge in FIG. 4B represents 30,000 occurrences. Representations of various values of N in the directed edges may be adjusted.

As should be appreciated, the various methods, devices, applications, features, etc., described with respect to FIGS. 4A-4B are not intended to limit example of the graph data structure 400. Accordingly, additional topology configurations may be used to practice the methods and systems herein described may be excluded without departing from the methods and systems disclosed herein.

FIGS. 5A-5B illustrate data structures with which the disclosure may be practiced in accordance with aspects of the present disclosure. The telemetry data 500A in FIG. 5A illustrates an example of the telemetry data and its data structure. In some aspects the telemetry data may be stored in the telemetry data storage 130. In some aspects the telemetry data is a log of operation records in operating an application. For example, the telemetry data may include Telemetry Data Identifier 504, User 506, Time Stamp 507, and Operation 508. The Telemetry Data Identifier 504 may identify an operation record as an entry as the telemetry data. The User 506 may specify a user who operates the application. For example, the Operation 508 may indicate one or more operations. Examples of the operations may include opening a file, editing the file, saving the file, renaming the file, closing the file, and deleting the file when an application program provide the functionalities. Different application programs may provide types of operations that differ from these in the example.

Entries of the telemetry data in FIG. 5A indicates, for example, an operation that relates to telemetry data entry 502 with telemetry data identifier 00000100 includes a user U001 creating a file at a time 2019-08-01-08:24:00. The user U001 then selects the editor for the file at 2019-08-01-08:26:21 as shown in the telemetry data identifier number 00000101. A set of operations as shown in operation session 510 includes eight operations from the telemetry data number 00000100 to 00000107, where the user U001 creates a file, selects the editor, edits content, saves the content in the file, select the editor, saves the file, and then closes the file in a time sequence. Another operation session 512 includes that the user U001 creates a file, selects the edit, edits the content, saves the file, renames the file, and closes the file during the period between 2019-08-02-8:14:00 and 2019-08-02-13:46:41. As shown in FIG. 5A, the telemetry data may include operation records of more than one users, U001 and U002, for example.

In some aspects, the usage graph generator 206 may use the two operation sessions 510, and 512, to generate a usage graph 300 in FIG. 3. For example, the usage graph generator 206 may combine the two operational sessions (510 and 512) to generate the Create-Select edge 304 from the Create File node 302 to the Select Editor node 306 with a count value 2, as shown in FIG. 3 to indicate the two occurrences of the user creating and then selecting the editor for the file based on the telemetry data.

The graphical signature data 500B in FIG. 5B illustrates an example of a list of graphical signatures of usage class. In some aspects the graphical signature data 500B may be stored in the graphical signature storage 132. The graphical signature 500B may include Graphical Signature Identifier 522, Usage Class Name 524, and Graph Data 526. The Graphical Signature Identifier identifies specific instances of graphical signatures. The Usage Class Name 524 provides a name of a usage class for respective instances of the graphical signatures. The Graph Data 526 includes data for graphs that describe the graphical signatures.

As illustrated in FIG. 5B, there are three graphical signatures. A graphical signature with an identifier 10000100 has a usage class name of a content producer along with graph data. Another graphical signature with an identifier 100000101 has a usage class name of a content reader along with graph data. Yet another graphical signature with an identifier 100000102 has a usage class name of a system administrator along with graph data. In some aspects, graphical signatures may be used as a reference or a graphical template representation of a typical series of operations that is classified as a particular usage class such as a content producer.

For example, the graphical signature (id=100000100) for a content producer may be illustrated as the graphical signature 400A in FIG. 4A. The graphical signature (id=100000101) for a content reader may be illustrated as the graphical signature 400B in FIG. 4B.

As should be appreciated, the types and the structures of data, data fields, etc., described with respect to FIGS. 5A and 5B are not intended to limit example of the data structures 500A-500B. Accordingly, additional types and structures of data and data fields may be used to practice the methods and systems herein and/or components described may be excluded without departing from the methods and systems disclosed herein.

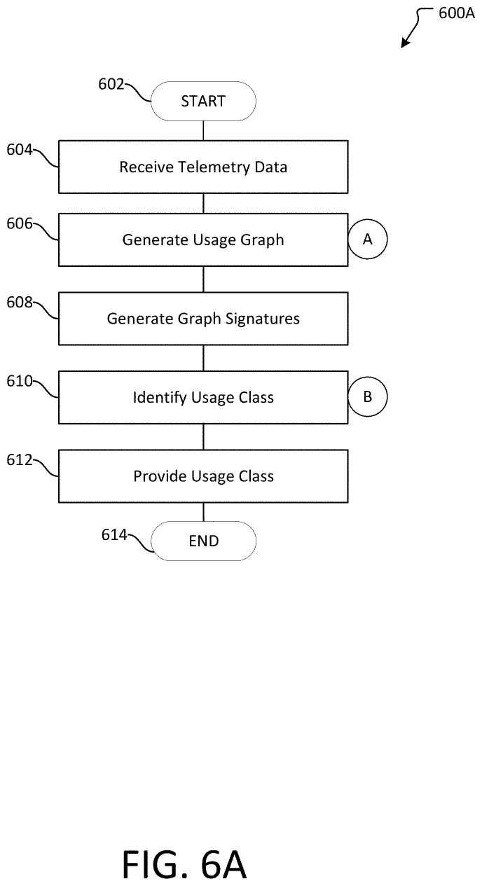

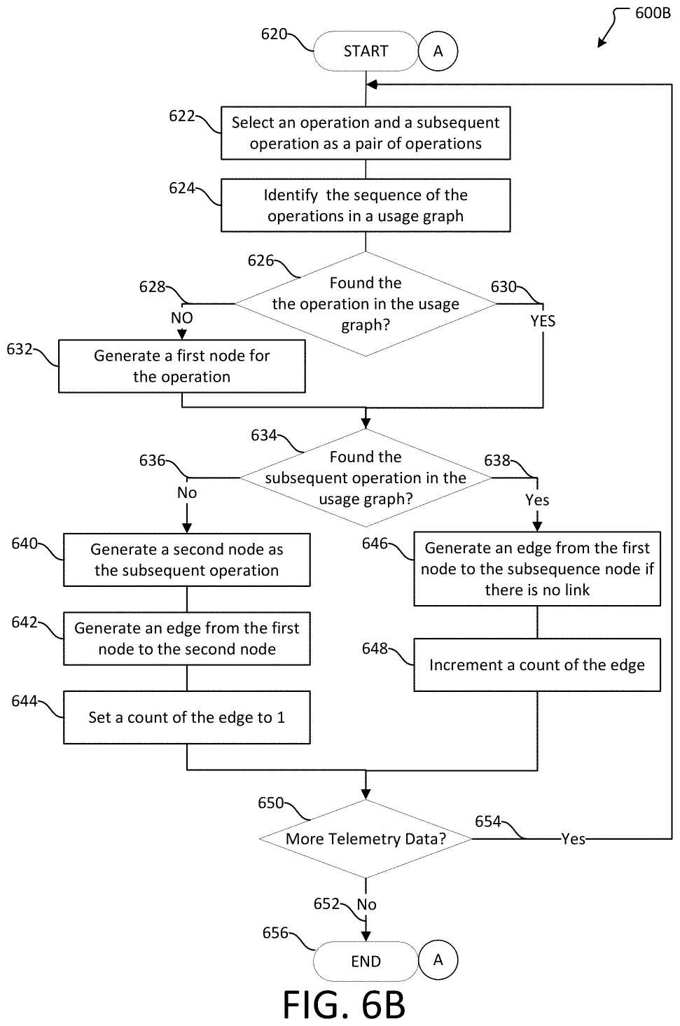

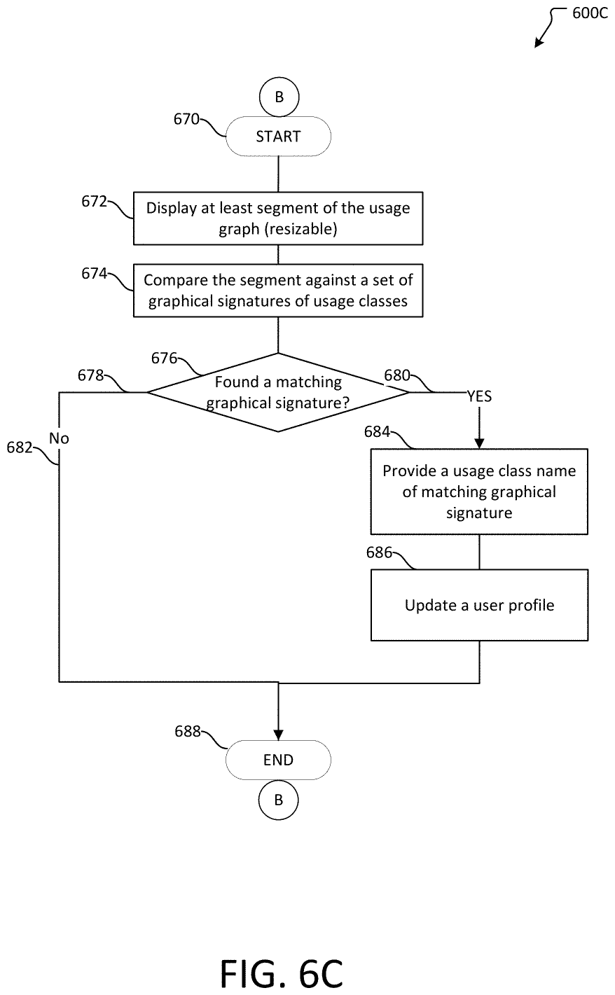

FIGS. 6A-6C illustrates examples of methods of generating a usage graph and classifying a usage according to an example system with which the disclosure may be practiced in accordance with aspects of the present disclosure.

A general order for the operations of the method 600A is shown in FIG. 6A. Generally, the method 600A starts with a start operation 602 and ends with an end operation 614. The method 600A can include more or fewer stages or can arrange the order of the stages differently than those shown in FIG. 6A. The method 600A can be executed as a set of computer-executable instructions executed by a computer system and encoded or stored on a computer readable medium. Further, the method 600A can be performed by gates or circuits associated with a processor, an ASIC, a FPGA, a SOC, or other hardware device. Hereinafter, the method 600A shall be explained with reference to the systems, component, devices, modules, software, data structures, data characteristic representations, signaling diagrams, methods, etc. described in conjunction with FIGS. 1-5 and 7-11.

The receive operation 604 may receive the telemetry data. The telemetry data may be as illustrated in the telemetry data storage 130 in FIG. 1 with the structure as described by an example telemetry data 500A in FIG. 5A. In at least some aspects, there may be a retrieve operation (not shown in FIG. 6) preceding the receive operation 604 to retrieve telemetry data of operations from respective application programs in the client computing devices 104A and 104B and/or server computing devices (110A, 110B, and 112) locally or through the network 108. As a result of the receive operation 604 the telemetry data may be stored in the telemetry data storage 130. In examples, the receive operation 604 may be performed by the telemetry data receiver 204 or the usage classifier 114.

The generate operation 606, by the usage graph generator 206 of the usage classifier 114 for example, may generate a usage graph based on the telemetry data that is stored in the telemetry data storage 130. In at least some aspects, the generate operation 604 generate a usage graph by analyzing the telemetry data, forming nodes based on operations by the user and edges based on a series of operations in time sequence. For example, operation sessions 510 and 512 as performed by a user U0001 as a part of telemetry data in FIG. 5A may be used to generate a usage graph 300 as described in FIG. 3. In some other aspects, a usage graph may be based on telemetry data of operations by multiple users. In aspects, among the purposes of generating the usage graph may include visualizing logs and enabling a comparison between the operations and respective templates of operations. FIG. 6B describes the generate operation 606 in details as indicated by (A). In some aspects, the generate operation 606 may be performed as unsupervised machine language processing based on clustering techniques, for example.

The retrieve operation 608, by the graphical signature generator 208 of the usage classifier 114, retrieves a set of graphical signatures from the graphical signature storage 132. In some aspects, examples of graphical signatures for usage classes of a content producer and a content reader is shown in FIGS. 4A and 4B. A data structure of the graphical signatures is described in FIG. 5B as an example. In some aspects, the retrieval of the graphical signatures may be for comparison against the usage graph as generated in the generate operation 606.

The identify operation 610, by the usage class identifier 210 of the usage classifier 114, may identify one or more usage classes that match the usage graph. In some aspects, the usage class identifier 210 may read the generated usage graph and the retrieved graphical signatures and compare the graphs to identify one or more graphical signatures that match the usage graph. For example, a pattern matching of graph segments may be used. In some aspects, the identify operation 610 may be performed as unsupervised machine language processing. Details of the identify operation 610 may be describe in FIG. 6C, as depicted by (B).

The provide operation 612, by a usage class provider 212 of the usage classifier 114 for example, may provide visual and/or graphical representations of the usage graph and the usage class associated with the usage graph. In some aspects, the provide operation 612 may store the association between the user and the usage class in the user profile storage 136. For example, the usage graph for providing as a visual representation may take forms of vector graphics that depict nodes and edges of a graph. Additionally or alternatively the visual objects may be in raster images. Various thicknesses or types of lines of the edges may indicate a number of times, a frequency, a ratio of particular sequences of operations from a node to another node, etc. For example, a thicker, directed edge may indicate a sequence of operations that occurs more frequently than other sequences. For example, the provide operation 612 may additionally or alternatively provide a vector graphics data of the usage graph 300 in FIG. 3 for displaying in user interface applications 700A-700D as shown in FIGS. 7A-7D. The user interface applications 700A-700D as shown in FIGS. 7A-7D may be used by operators to visually check the structure of the usage graph and visually compare against graphical signatures for analysis. Such tools may be useful for understanding sequences of operations to use operational functionalities of the application based on varying usage classes such as a content producer, a content reader, and a system administrator, and for comparing against design intent for improving the functionality and operational efficiencies of the application.

As should be appreciated, operations 602-614 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

A general order for the stages of the method 600B is shown in FIG. 6B. Generally, the method 600B starts with a start operation 620 and ends with an end operation 656. The method 600B can include more or fewer stages or can arrange the order of the stages differently than those shown in FIG. 6B. The method 600B can be executed as a set of computer-executable instructions executed by a computer system and encoded or stored on a computer readable medium. Further, the method 600B can be performed by gates or circuits associated with a processor, an ASIC, a FPGA, a SOC, or other hardware device. Hereinafter, the method 600B shall be explained with reference to the systems, component, devices, modules, software, data structures, data characteristic representations, signaling diagrams, methods, etc. described in conjunction with FIGS. 1-5 and 7-11.

The method 600B illustrates steps of generating a usage graph based on telemetry data. In some aspects, the method 600B details the generate operation 606 of FIG. 6A. The select operation 622 may select an operation and a subsequent operation from telemetry data. For example, operations in the telemetry data as identified by 00000100 and 00000101 may be selected from the telemetry data 500A as shown in FIG. 5A. In examples, timestamps may be used to determine a sequence order. For example, the operation 00000101 is subsequent to the operation 00000100 because the time stamp 507 of the operation 00000101 (2019-08-01-08:26:21) is about two seconds later than the operation 00000100 (2019-08-01-08:24:00). In some other example, the operation 00000108 (2019-08-01-09:00:18) by user U002 occurs after the operation 00000100 (2019-08-01-08:24:00) by another user U001. In yet another example, the operation 0000114 (2019-08-02-08:14:00) by user U001 occurs after the operation 00000100 (2019-08-01-08:24:00) by the same user U001 but under a separate session (e.g., operation sessions 510 and 5012). In some aspects, a usage graph may be generated by including operation records from more than one session of a user. Operation records from multiple sessions (such as the sessions or the groups of operation records 510, 512, and 514 in FIG. 5A) may be included in generating the usage graph, for example. In some other aspects, operation records based on more than one user may be combined in generating a usage graph. Operation records from multiple users, such as all the entries in the telemetry data 500A may be used to generate the usage graph, for example.

The identify operation 624 identifies the sequence of the operations in an existing usage graph. For example, the identify operation may identify the sequence of the two operations Open file (00000100) followed by Select Editor (00000101), which may be linked by an edge in an existing graph. In some aspects, graph matching techniques, including but not limited to pattern matching techniques may be used to identify the sequence.

The compare operation 626 may compare the identified sequence of the operations and the usage graph being created. When the operation that matches the sequence of the operation is not found in the usage graph (i.e., NO 628), the generate operation 628 may generate a first node for the operation 632 in the usage graph. In some aspects, the graph data for the usage graph may be stored in the form of tables of nodes and edges (Not shown in figures). New entries of the respective nodes and the edge that constitute the identified sequence of the operations may be added to the tables to generate the nodes and the edge. When the operation that matches the sequence of the operation is found in the usage graph (i.e., YES 630), the method 600B proceeds to the next conditional step 634.

The compare operation 634 may compare the node for the subsequent operation and the usage graph being crated. When the node that corresponds to the subsequent user operation is found in the usage graph (i.e., YES 638), the generate operation 646 generates an edge from the first node to the subsequent node if there is no edge found. In some aspects, the graph data for the usage graph may be stored in the form of tables of nodes and edges. New entries of the respective nodes and the edge that constitute the identified sequence of the operations may be added to the tables to generate the nodes and the edge. The increment operation 648 increments a count that relates to the edge by one. In some aspects, the count maintains a number of occurrences of the sequence of the operations.

When the subsequent user operation is not found in the usage graph (i.e., No 636), then the generate operation 640 may generate a second node that corresponds to the subsequent operation. In some aspects, the graph data for the usage graph may be stored in the form of tables of nodes and edges (Not shown in figures). A new entry of a node may be added to the tables for the second node. An entry for the node may include an identifier of the node, a name of an operation, a timestamp, and a user, for example.

The generate operation 642 may generate an edge from the first node to the second node. In some aspects, the graph data for the usage graph may be stored in the form of tables of nodes and edges (Not shown in figures). A new entry of the edge may be added to the tables. An entry for the edge may include an identifier of the edge, a timestamp, an identifier of a first node where the edge originates from, an identifier of a second node that the edge connects to, and a count, for example. In some aspect, the edge may be directional. The count of the edge may indicate a number of occurrence of the sequence of the operations, which is represented by the edge and the first node and the second node.

The set operation 644 may set a count value of the edge to 1, for example. The initial value of the count is not limited to 1 (one) but a predetermined initial value in the usage classifier application 114. The count represents a number of occurrences of the sequence of the operations. The count may be revised as the usage graph is generated based on the telemetry data 500A.

The compare operation 650 may compare the usage graph being generated and the telemetry data 500A. When there is remaining telemetry data for generating the usage graph, generating the usage graph continues (i.e., Yes 654) by selecting more operations from the telemetry data 500A as shown in the select operation 622. The process ends at END 656 when there is no more telemetry data to use for generating the usage graph (i.e., No 652).

As should be appreciated, operations 620-656 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

A general order for the stages of the method 600C is shown in FIG. 6C. Generally, the method 600C starts with a start operation 670 and ends with an end operation 688. The method 600C can include more or fewer stages or can arrange the order of the stages differently than those shown in FIG. 6C. The method 600C can be executed as a set of computer-executable instructions executed by a computer system and encoded or stored on a computer readable medium. Further, the method 600B can be performed by gates or circuits associated with a processor, an ASIC, a FPGA, a SOC, or other hardware device. Hereinafter, the method 600C shall be explained with reference to the systems, component, devices, modules, software, data structures, data characteristic representations, signaling diagrams, methods, etc. described in conjunction with FIGS. 1-5 and 7-11.

The method 600C illustrates steps of identifying a usage class based on the usage graph and a set of graphical signatures of operations. The display operation 672 displays at least a segment of the usage graph. In some aspects the displayed usage graph may be adjusted to a number of nodes and a range of the value N of the edges for displaying. In some other aspects, a user interface tool, a graphical use interface tool for example, may be provided to interactively display the usage graph and graphical signatures by adjusting the thickness of the directed edges by controlling the range of values of N and a range of dates used in the telemetry data, for example of the usage graph and the graphical signatures.

The compare operation 674 compares the clusters against a set of graphical signatures of usage classes. The compare operation 674 may be performed by node-edge pattern matching operations between the usage graph and the graphical signatures. The decision operation 676 may decide whether a matching graphical signature is found. In some aspects, the decision operation 676 may receive an input from the user about the matching graphical signature through visual interactive operations on comparing the usage graph and the set of graphical signatures. If found (i.e., Yes 680), then the provide operation 684 provides information about the matching graphical signature, a usage class name of the matching graphical signature for example. The update operation 686 updates a user profile that associates a user with a usage class. In some aspect, the association of the user and the usage class may be stored in the usage profile storage 136, for example. If the matching graphical signature is not found (i.e., No 678), the method of identifying usage class ends without providing a usage class name because a usage class is not found. In some aspects, the graphical user interface too may provide the usage graph and at least one of the graphical signatures side by side for visual comparison and provide an input user interface to receive the input from the operator to select a graphical signature and the corresponding usage class for the usage graph and the user.

As should be appreciated, operations 670-688 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

FIGS. 7A-7D illustrates examples of a user interface providing a usage graph and a matching usage classification according to an example system with which the disclosure may be practiced in accordance with aspects of the present disclosure. In some aspect, the user interface is a graphical user interface that interactively displays the usage graph and a graphical signature with a usage class name, which matches with the usage graph.

In some aspects, the Usage Classifier window in FIG. 7A may provide the graphical user interface 700A displaying a usage graph 710A (with a title “Usage Graph 1”). The usage graph 710A may be based on the usage graph 300 of FIG. 3, which the usage graph generator 206 in FIG. 2 generates based on the telemetry data 500A (as shown in FIG. 5A) stored in the telemetry data storage 130 in FIG. 1. The usage graph 710A may be based on the telemetry data 500A for user U001 and conditions as specified by an N-range control 702A and a date range control 704A. The N-range control 702A interactively receives a range of values of N (count), between N=2 and N=3, for example. The date range control 704A specifies a start date and an end date of telemetry data (August 1 and August 2, for example) used to generate the usage graph. In some aspect, the usage graph 710A satisfies the conditions, and thus edges with a value of a count outside the range along with associated nodes may be displayed and other parts may be removed from being displayed. Counts in respective edges may indicate a number of times that respective sequences of operations as represented by the respective edges and both nodes at the ends of the respective edges have occurred.

The Usage Classifier window may also display graphical signatures 712A for selection by the operator. The graphical signatures 712A include a graphical signature with a usage class Content Provider and another graphical signature with a usage class Content Reader, along with a selection button to receive the operator's input for selecting a graphical signature that the best matches with the usage graph 710A. The graphical signatures may be horizontally scrollable to display more graphical signatures by selecting one of horizontal arrow buttons on two sides of the graphical signatures 712A. In some aspects, the graphical signatures may be displayed without labels of nodes and operations (“Node Label: OFF”), allowing the operator to compare shapes to determine the matching graphical signature for the usage graph 710A. A thickness style of the edges indicate how likely the sequence of operations occurs; thicker the edge is more likely the edge is. By displaying the usage graph and the matching graphical signature side by side, a user of the graphical user interface may visually compare the graphs based on shapes and analyze deviations from each other. While not shown in FIG. 7A, the graphs may be edited by using interactive tools such as adding/removing a node or an edge.

FIG. 7B provides an example of the graphical user interface tool that enables the user to compare a usage graph 710B and a graphical signature 712B and to receive input for setting an association between the usage graph 710B and the graphical signature 712B thereby setting a usage class for the user. In some aspect, the graphical user interface tool provides a set of controls to set ranges of parameter values for displaying the usage graph 710B and the graphical signature 712B. For example, the count (N) range control 702B for the usage graph 710B may be set between 2 and 3. The date range control 704B may be set between August 1 and August 2. Accordingly, a directed edge with count (e.g., N=1) that is outside the range is not shown and nodes that the directed edge edges to are not shown, For example, the Rename File node 320 with the Save-Rename edge 318 and the Rename-Close edge 322 with count=1 respectively are not displayed in the usage graph 710B, for example. The usage graph 710B is a usage graph for the user U001 based on operation sessions 510 and 5012 in FIG. 5A with specific parameter value ranges.

In some aspects, the graphical user interface tool 700B may provide a graphical signature 712B based on conditions as set forth by the operator. For example, the count range control 706B may limit the range of count to be between 100 and 3,000. The date range control 708B may limit the range of dates (e.g., January 1 through August 15) to use to parse the telemetry data 500A in dynamically generating the graphical signatures. In some aspects, receiving a selection by the operator to set usage class 714 may generate an association between a user for the usage graph (U001) with a usage class (Content Producer) by receiving a specific usage class for the association.

As described in FIG. 7C, the graphical user interface may provide adjust a graphical signature as the graphical signature is dynamically generated based on the telemetry data 500A using the count (N) range control 706C and the date range control 708C as conditional parameter values for parsing the telemetry data 500A. For example, the graphical signature 712C is generated based on the count range between 10 and 40,000 and the date range from April 1 and August 15. In some aspect, the graphical signature 712C may include telemetry data for multiple users for the date range as specified. Thickness of the directed edges represent counts occurrences of respective sequences of events. The graphical signature 712C may be a collection and/or combination of shapes or images of the usage graphs for multiple users for the date range. For example, the graphical signature 712C may contains both of the exemplar graphical signatures 400A and 400B. By adjusting the count range 706C and the date range 708C, the graphical user interface 700C may provide varying views of the graphical signature 712C. Setting a wider range of counts and dates may result in displaying more nodes and edges. Setting a narrower range of counts and dates may results in display less nodes and edges. In some aspects, the graphical user interface may receive an input command (not shown) to save the displayed graphical signature 712C for a future reference to be used to compare against usage graphs.

FIG. 7D shows an example of the graphical user interface 700D with a count (N) range control 706D set between 10 and 1,500 and the date range control 708D set between February 1 and August 15. Based on the conditions of the ranges, the graphical signature 712D may include less number of nodes and directed edges than the graphical signature 712C of FIG. 7C. In some aspect, the graphical user interface 700D may provide clipping and/or splitting the graphical signature into parts for storing in various folders. For example, the folder list 718 may provide a list of existing folders with respective names along with a number of partial or a whole graphical signatures stored inside the respective folders. For example, the Create File folder contains 100 clipped parts of the graphical signatures (or shapes or images of shapes). The unlabeled shape 720 may represent the graphical signature 712D without node labels for displaying in case of shape comparison as depicted in the graphical signatures 712A in FIG. 7A. The graphical interface 700D may provide a selection window 716 where the operator may specify a rule of clipping a shape (with the condition of clipping when the graph contains a Create file node, thus clipping nodes and directed edges that starts the Create File node, for example). Additionally or alternatively, the selection window 716 may provide receiving input from the operator to set a name of a folder to classify and/or store the clipped shape (Create File, for example), and set a market name (or a usage class) (Content Producer, for example), and an input button to receive a command to save the clip shape accordingly or a cancel saving into the folder.

As should be appreciated, the usage graphs 710A-710B and the graphical signatures 712A-712D in FIGS. 7A-7D are described for purposes of illustrating the graphical user interfaces 700A-700D of the present methods and systems and are not intended to limit the disclosure to a particular sequence of steps, e.g., steps may be performed in differing order, additional steps may be performed, and disclosed steps may be excluded without departing from the present disclosure.

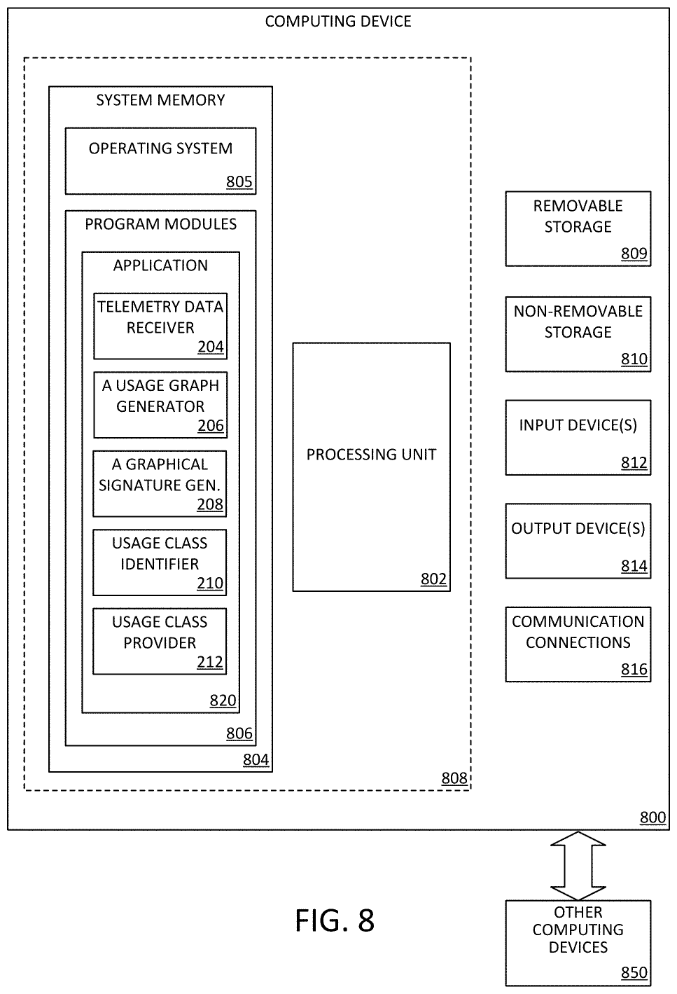

As an example of a processing device operating environment, refer to the exemplary operating environments depicted in FIGS. 8-11. In other instances, the components of systems disclosed herein may be distributed across and executable by multiple devices. For example, input may be entered on a client device and information may be processed or accessed from other devices in a network (e.g. server devices, network appliances, other client devices, etc.).

FIGS. 8-11 and the associated descriptions provide a discussion of a variety of operating environments in which aspects of the disclosure may be practiced. However, the devices and systems illustrated and discussed with respect to FIGS. 8-11 are for purposes of example and illustration and are not limiting of a vast number of computing device configurations that may be utilized for practicing aspects of the disclosure, described herein.

FIG. 8 is a block diagram illustrating physical components (e.g., hardware) of a computing device 800 with which aspects of the disclosure may be practiced. The computing device components described below may be suitable for the computing devices described above, including the client computing devices 104A-B and the server computing devices 114 and 110A-B. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 and one or more program modules 806 suitable for performing the various aspects disclosed herein such as a telemetry data receiver 204, a usage graph generator 206, a graphical signature generator (gen.) 208, a usage class identifier 210, and a usage class provider 212. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., application 820) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

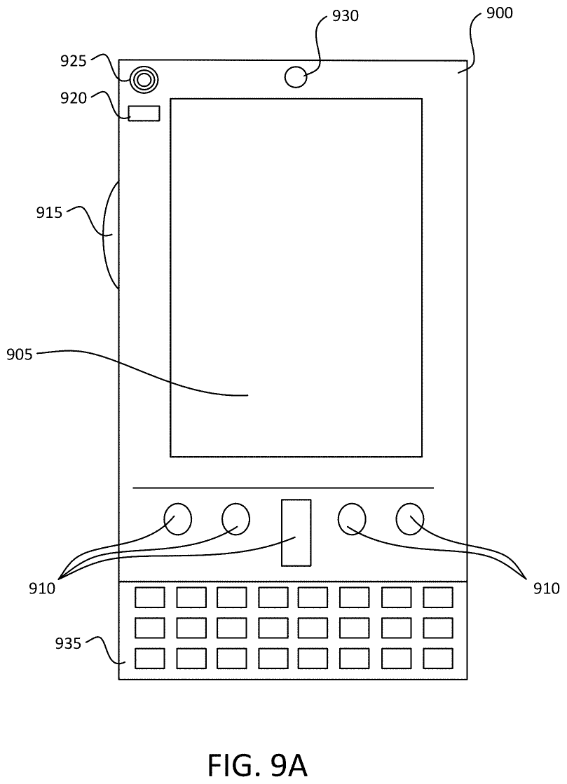

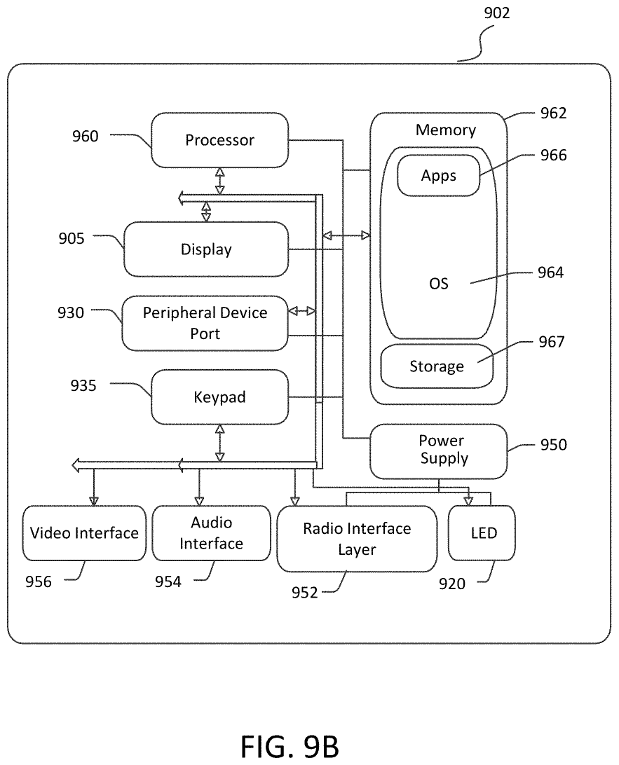

FIGS. 9A and 9B illustrate a mobile computing device 900, for example, a mobile telephone, a smart phone, wearable computer (such as a smart watch), a tablet computer, a laptop computer, and the like, with which embodiments of the disclosure may be practiced. In at least some aspects, the client may be a mobile computing device. With reference to FIG. 9A, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or less input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In at least some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In at least some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 967 may be used to store persistent information that should not be lost if the system 902 is powered down. The application programs 966 may use and store information in the non-volatile storage area 967, such as e-mail or other messages used by an e-mail application, and the like. A synchronization application (not shown) also resides on the system 902 and is programmed to interact with a corresponding synchronization application resident on a host computer to keep the information stored in the non-volatile storage area 967 synchronized with corresponding information stored at the host computer. As should be appreciated, other applications may be loaded into the memory 962 and run on the mobile computing device 900 described herein (e.g., search engine, extractor module, relevancy ranking module, answer scoring module, etc.).

The system 902 has a power supply 950, which may be implemented as one or more batteries. The power supply 950 might further include an external power source, such as an AC adapter or a powered docking cradle that supplements or recharges the batteries.

The system 902 may also include a radio interface layer 952 that performs the function of transmitting and receiving radio frequency communications. The radio interface layer 952 facilitates wireless connectivity between the system 902 and the “outside world,” via a communications carrier or service provider. Transmissions to and from the radio interface layer 952 are conducted under control of the operating system 964. In other words, communications received by the radio interface layer 952 may be disseminated to the application programs 966 via the operating system 964, and vice versa.

The visual indicator 920 may be used to provide visual notifications, and/or an audio interface 954 may be used for producing audible notifications via the audio transducer 925. In the illustrated embodiment, the visual indicator 920 is a light emitting diode (LED) and the audio transducer 925 is a speaker. These devices may be directly coupled to the power supply 950 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 954 is used to provide audible signals to and receive audible signals from the user. For example, in addition to being coupled to the audio transducer 925, the audio interface 954 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 956 that enables an operation of an on-board camera 930 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 967.

Data/information generated or captured by the mobile computing device 900 and stored via the system 902 may be stored locally on the mobile computing device 900, as described above, or the data may be stored on any number of storage media that may be accessed by the device via the radio interface layer 952 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 952 or via a distributed computing network. Similarly, such data/information may be readily transferred between computing devices for storage and use according to well-known data/information transfer and storage means, including electronic mail and collaborative data/information sharing systems.

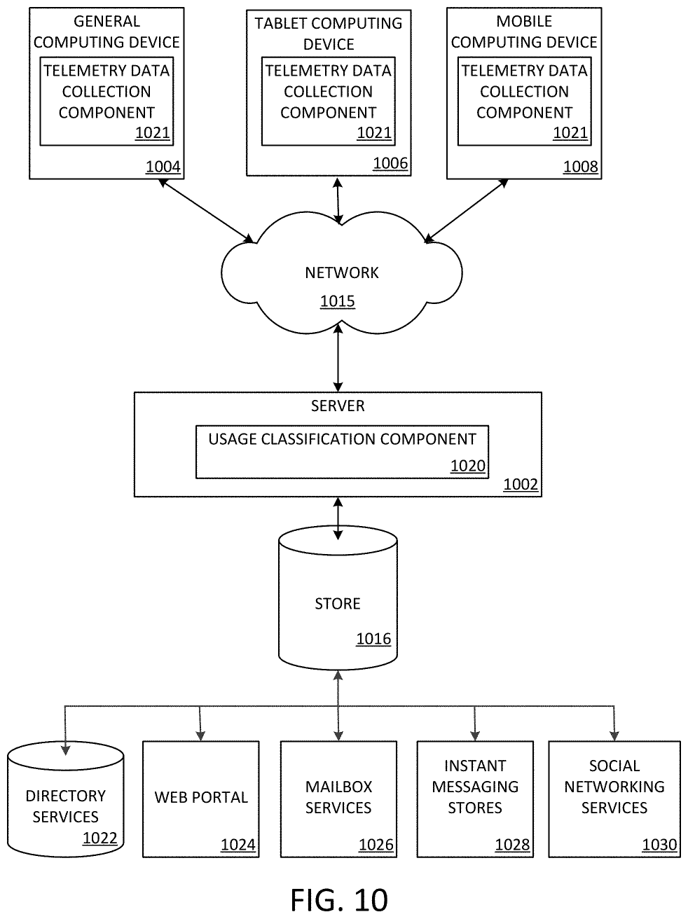

FIG. 10 illustrates one aspect of the architecture of a system for processing data received at a computing system from a remote source, such as a personal computer 1004, tablet computing device 1006, or mobile computing device 1008, as described above. Content displayed at server device 1002 may be stored in different communication channels or other storage types. For example, various documents may be stored using a directory service 1022, a web portal 1024, a mailbox service 1026, an instant messaging store 1028, or a social networking site 1030. A telemetry data collection component 1021 may be employed by a client that communicates with server device 1002, and/or usage classification component 1020 may be employed by server device 1002. The server device 1002 may provide data to and from a client computing device such as a personal computer 1004, a tablet computing device 1006 and/or a mobile computing device 1008 (e.g., a smart phone) through a network 1015. By way of example, the computer system described above may be embodied in a personal computer 1004, a tablet computing device 1006 and/or a mobile computing device 1008 (e.g., a smart phone). Any of these embodiments of the computing devices may obtain content from the store 1016, in addition to receiving graphical data useable to be either pre-processed at a graphic-originating system, or post-processed at a receiving computing system.

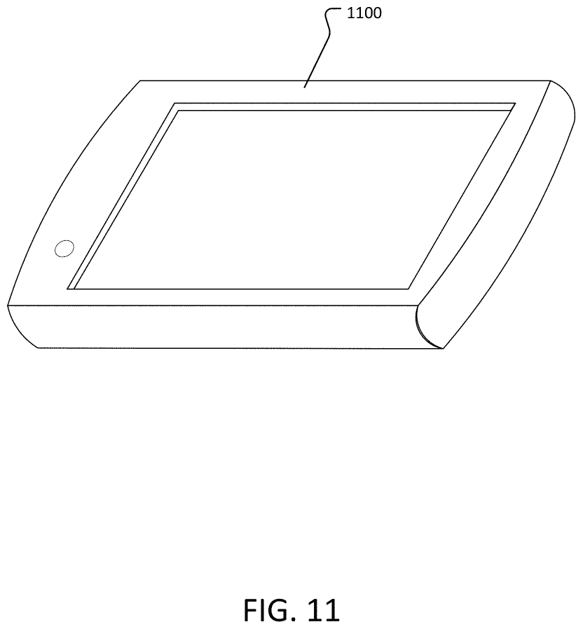

FIG. 11 illustrates an exemplary tablet computing device 1100 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

An aspect herein can include a computer-implemented method for classifying usage based on telemetry data for operating one or more computers, the method comprising: receiving telemetry data of operations on one or more computers; generating a usage graph, wherein the usage graph represents a sequence of the operations; retrieving one or more predefined graphical signatures, wherein the one or more predefined graphical signatures represent distinct usage classes; identifying a usage class based on the usage graph and the one or more predefined graphical signatures, wherein the usage class relates to at least one of the one or more predefined graphical signatures that match the usage graph; and providing one or more visual representations of the usage class.

One or more of the above aspects, wherein the telemetry data comprises one or more operations, and wherein an operation comprises: a user identifier; a timestamp of the operation; and an operation identifier for the operation.

One or more of the above aspects, wherein a usage graph comprises: a first node, wherein the first node represents a first operation; a second node, wherein the second node represents a second operation having occurred subsequent to the first operation based on timestamps of the first operation and the second operation; and an edge, wherein the edge connects from the first node to the second node, the edge representing a sequence of the second operation occurring after the first operation, the edge further comprising a count representing a number of times the sequence has occurred according to the telemetry data.

One or more of the above aspects comprise generating the first node of the usage graph based on the first operation in the telemetry data; generating the second node of the usage graph based on the second operation in the telemetry data; and generating the edge, wherein the edge connects from the first node to the second node, the edge representing a sequence of the first operation followed by the second operations.

One or more of the above aspects comprise parsing the usage graph; clustering the usage graph into one or more portions; comparing the graph segments against a set of graphical signatures, wherein graphical signatures relate to a set of usage classes; identifying one of the graphical signatures that matches the graph segment; and providing a usage class from the set of usage classes based on the identification of the one of the graphical signatures.

One or more of the above aspects comprise classifying the one or more portions of the usage graph based at least on a value of the count, wherein the value of the count of the edge depicts a tendency of the sequence of the operations.

One or more of the above aspects, wherein the usage class comprises: a content producer, a content consumer, and an application administrator.

One or more of the above aspects comprise generating a visual representation of the usage graph, wherein the edge visually represents a value of the count, and wherein the usage graph and the predefined graphical signatures are based on a Markov chain model.

One or more of the above aspects, wherein the generation of the usage graph is based on an unsupervised machine language model, wherein the unsupervised machine language model includes clustering of the usage graph.

One or more of the above aspects comprise providing the one or more visual representations of the usage graph and at least one of the predefined graphical signature through a graphical user interface for visual comparison.

An aspect herein can include a computer devise, comprising: at least one processing unit; and at least one memory storing computer executable instructions for classifying usage based on telemetry data for operating one or more computers, the instructions when executed by the at least one processing unit causing the computing device to perform steps of: receiving the telemetry data of operating one or more computers; generating a usage graph based on the telemetry data of operating the one or more computers, wherein the usage graph comprises a plurality of nodes and one or more directed edges with a count; retrieving predefined a graphical signature, wherein the predefined graphical signature represents one or more usage classes, wherein the predefined graphical signature comprises a plurality of nodes and directed edges between two of the nodes, and wherein the nodes represent operations and the directed edges represent sequences of the operations; identifying a usage class based on the usage graph and the one or more predefined graphical signatures, wherein the usage class relates to at least one of the one or more predefined graphical signatures matching the usage graph; and providing one or more visual representations of the usage class.

One or more of the above aspects, wherein the telemetry data comprises one or more operations, and wherein the one of the one or more operations comprises: a user identifier; a timestamp of an operation; and an operation identifier for the operation.

One or more of the above aspects, wherein a usage graph comprises: a first node, wherein the first node represents a first operation; a second node, wherein the second node represents a second operation having occurred subsequent to the first operation; and an edge, wherein the edge connects from the first node to the second node, the edge representing a sequence of the second operation occurring after the first operation, the edge further comprising a count representing a number of times the sequence has occurred according to the telemetry data.

One or more of the above aspects comprise generating the first node of the usage graph based on the first operation in the telemetry data; generating the second node of the usage graph based on the second operation in the telemetry data; and generating the edge, wherein the edge connects from the first node to the second node, the edge representing a sequence of the first operation followed by the second operations.

One or more of the above aspects comprise parsing the usage graph; clustering the usage graph into one or more portions; comparing the graph segments against a set of graphical signatures, wherein graphical signatures relate to a set of usage classes; identifying one of the graphical signatures that matches the graph segment; and providing a usage class from the set of usage classes based on the identification of the one of the graphical signatures.

Another aspect herein can include a computer storage medium storing computer executable instructions for classifying usage of operations based on telemetry data, the instructions when executed by at least one processing unit, cause the at least one processing unit to perform steps of: receiving telemetry data of operations on one or more computers; generating a usage graph, wherein the usage graph represents the operations based on the receipt of the telemetry data; retrieving one or more predefined graphical signatures, wherein the one or more predefined graphical signatures represent distinct operational roles based on the operations; identifying a usage class based on the usage graph and the one or more predefined graphical signatures, wherein the usage class relates to one of the one or more predefined graphical signatures matching the usage graph; and providing one or more visual representations of the usage class.

One or more of the above aspects, wherein the telemetry data comprises one or more operations, and wherein the one of the one or more operations comprises: a user identifier; a timestamp of an operation; and an operation identifier for the operation.

One or more of the above aspects, wherein a usage graph comprises: a first node, wherein the first node represents a first operation; a second node, wherein the second node represents a second operation having occurred subsequent to the first operation; and an edge, wherein the edge connects from the first node to the second node, the edge representing a sequence of the second operation occurring after the first operation, the edge further comprising a count representing a number of times the sequence has occurred according to the telemetry data.

One or more of the above aspects, the steps further comprising: generating the first node of the usage graph based on the first operation in the telemetry data; generating the second node of the usage graph based on the second operation in the telemetry data; and generating the edge, wherein the edge connects from the first node to the second node, the edge representing a sequence of the first operation followed by the second operations.

One or more of the above aspects, the steps further comprising parsing the usage graph; clustering the usage graph into one or more portions; comparing the graph segments against a set of graphical signatures, wherein graphical signatures relate to a set of usage classes; identifying one of the graphical signatures that matches the graph segment; and providing a usage class from the set of usage classes based on the identification of the one of the graphical signatures.

Any of the one or more above aspects in combination with any other of the one or more above aspect.

Any of the one or more aspects as described herein.

What is claimed is:

1. A computer-implemented method for classifying usage based on telemetry data for operating one or more computers, the method comprising:
receiving telemetry data of operations on one or more computers;
generating a usage graph based on the telemetry data, wherein the usage graph represents a sequence of the operations;
generating one or more predefined graphical signatures based on the telemetry data associated with one or more users, wherein the one or more predefined graphical signatures represent distinct usage classes;
identifying a usage class based on the usage graph and the one or more predefined graphical signatures through use interaction based on a graphical user interface, wherein the usage class relates to at least one of the one or more predefined graphical signatures that match the usage graph; and
providing one or more visual representations of the usage class.

2. The computer-implemented method of claim 1, wherein the telemetry data comprises one or more operations, and wherein an operation comprises:
a user identifier;
a timestamp of the operation; and
an operation identifier for the operation.

3. The computer-implemented method of claim 2, wherein a usage graph comprises:
a first node, wherein the first node represents a first operation;
a second node, wherein the second node represents a second operation having occurred subsequent to the first operation based on timestamps of the first operation and the second operation; and
an edge, wherein the edge connects from the first node to the second node, the edge representing a sequence of the second operation occurring after the first operation, the edge further comprising a count representing a number of times the sequence has occurred according to the telemetry data.

4. The computer-implemented method of claim 3, the method further comprising:
generating the first node of the usage graph based on the first operation in the telemetry data;
generating the second node of the usage graph based on the second operation in the telemetry data; and
generating the edge, wherein the edge connects from the first node to the second node, the edge representing a sequence of the first operation followed by the second operations.

5. The computer-implemented method of claim 4, the method further comprising:
parsing the usage graph;
clustering the usage graph into one or more portions;
comparing the graph segments against a set of graphical signatures, wherein graphical signatures relate to a set of usage classes;
identifying one of the graphical signatures that matches the graph segment; and
providing a usage class from the set of usage classes based on the identification of the one of the graphical signatures.

6. The computer-implemented method of claim 5, the method further comprising:
classifying the one or more portions of the usage graph based at least on a value of the count, wherein the value of the count of the edge depicts a tendency of the sequence of the operations.

7. The computer-implemented method of claim 6, wherein the usage class comprises:
a content producer,
a content consumer, and
an application administrator.

8. The computer-implemented method of claim 6, the method further comprising:
generating a visual representation of the usage graph, wherein the edge visually represents a value of the count, and wherein the usage graph and the predefined graphical signatures are based on a Markov chain model.

9. The computer-implemented method of claim 6, wherein the generation of the usage graph is based on an unsupervised machine language model, wherein the unsupervised machine language model includes clustering of the usage graph.

10. The computer-implemented method of claim 6, the method further comprising:
providing the one or more visual representations of the usage graph and at least one of the predefined graphical signature through a graphical user interface for visual comparison.

11. A computing device, comprising:
at least one processing unit; and
at least one memory storing computer executable instructions for classifying usage based on telemetry data for operating one or more computers, the instructions when executed by the at least one processing unit causing the computing device to perform steps of:
receiving the telemetry data of operating one or more computers;
generating a usage graph based on the telemetry data of operating the one or more computers, wherein the usage graph comprises a plurality of nodes and one or more directed edges with a count;
generating a predefined graphical signature based on the telemetry data associated with one or more users, wherein the predefined graphical signature represents one or more usage classes, wherein the predefined graphical signature comprises a plurality of nodes and directed edges between two of the nodes, and wherein the nodes represent operations and the directed edges represent sequences of the operations;
identifying a usage class based on the usage graph and the predefined graphical signature through user interaction based on a graphical user interface, wherein the usage class relates to the predefined graphical signature matching the usage graph; and
providing one or more visual representations of the usage class.

12. The computing device of claim 11, wherein the telemetry data comprises one or more operations, and wherein the one of the one or more operations comprises:
a user identifier;
a timestamp of an operation; and
an operation identifier for the operation.

13. The computing device of claim 12, wherein a usage graph comprises:
a first node, wherein the first node represents a first operation;
a second node, wherein the second node represents a second operation having occurred subsequent to the first operation; and
an edge, wherein the edge connects from the first node to the second node, the edge representing a sequence of the second operation occurring after the first operation, and the edge further comprising a count representing a number of times the sequence has occurred according to the telemetry data.

14. The computing device of claim 13, the steps further comprising:
generating the first node of the usage graph based on the first operation in the telemetry data;
generating the second node of the usage graph based on the second operation in the telemetry data; and
generating the edge, wherein the edge connects from the first node to the second node, the edge representing a sequence of the first operation followed by the second operations.

15. The computing device of claim 14, the steps further comprising:
parsing the usage graph;
clustering the usage graph into one or more portions;
comparing the graph segments against a set of graphical signatures, wherein graphical signatures relate to a set of usage classes;
identifying one of the set of graphical signatures that matches the graph segment; and
providing a usage class from the set of usage classes based on the identification of the one of the graphical signatures.

16. A computer storage medium storing computer executable instructions for classifying usage of operations based on telemetry data, the instructions when executed by at least one processing unit, cause the at least one processing unit to perform steps of:
receiving telemetry data of operations on one or more computers;
generating a usage graph, wherein the usage graph represents the operations based on the receipt of the telemetry data;
generating one or more predefined graphical signatures based on the telemetry data associated with one or more users, wherein the one or more predefined graphical signatures represent distinct usage classes based on the operations;
identifying a usage class based on the usage graph and the one or more predefined graphical signatures through use interaction based on a graphical user interface, wherein the usage class relates to one of the one or more predefined graphical signatures matching the usage graph; and
providing one or more visual representations of the usage class.

17. The computer storage medium of claim 16, wherein the telemetry data comprises one or more operations, and wherein the one of the one or more operations comprises:
a user identifier;
a timestamp of an operation; and
an operation identifier for the operation.

18. The computer storage medium of claim 17, wherein a usage graph comprises:
a first node, wherein the first node represents a first operation;
a second node, wherein the second node represents a second operation having occurred subsequent to the first operation; and
an edge, wherein the edge connects from the first node to the second node, the edge representing a sequence of the second operation occurring after the first operation, and the edge further comprising a count representing a number of times the sequence has occurred according to the telemetry data.

19. The computer storage medium of claim 18, the steps further comprising:
generating the first node of the usage graph based on the first operation in the telemetry data;
generating the second node of the usage graph based on the second operation in the telemetry data; and
generating the edge, wherein the edge connects from the first node to the second node, the edge representing a sequence of the first operation followed by the second operations.

20. The computer storage medium of claim 19, the steps further comprising:
parsing the usage graph;
clustering the usage graph into one or more portions;
comparing the graph segments against a set of graphical signatures, wherein graphical signatures relate to a set of usage classes;
identifying one of the set of graphical signatures that matches the graph segment; and
providing a usage class from the set of usage classes based on the identification of the one of the graphical signatures.
